(19) United States
(12) Patent Application Publication
(10) Pub. No.: US 2007/0078655 A1
(43) Pub. Date: Apr. 5, 2007

(54) Report generation system with speech output

(75) Inventors: Marc D. Semkow, Burnaby (CA); Clifton H. Bromley, New Westminister (CA); Eric G. Dorgelo, Port Moody (CA); Kevin G. Gordon, Annacis Island Delta (CA); Douglas J. Reichard, Fairview, OH (US); Shafin A. Virji, Vancouver (CA)

Correspondence Address: ROCKWELL AUTOMATION, INC./(AT), ATTENTION: SUSAN M. DONAHUE, 1201 SOUTH SECOND STREET, MILWAUKEE, WI, 53204, US

(73) Assignee: Rockwell Automation Technologies, Inc., Mayfield Heights, OH (US)

(21) Appl. No.: 11/241,491

(22) Filed: Sep. 30, 2005

(51) Int. Cl. G10L 13/00

(52) U.S. Cl. 704/258

(57) ABSTRACT

A text- or data-to-speech architecture that communicates speech to a user based on data and/or input text. In an industrial automation environment, the input text can be generated by the automation system from alarm logs, notification messages, status messages, operational parameters, current alarm conditions, production numbers, work orders to be executed, planned maintenance information, and messages from other people, for example. A system is provided that includes a conversion component that receives text and converts the text into an audible format, and a speech component that receives the audible format and presents (or outputs) the text as recognizable speech. The speech component can include a text-to-speech engine that processes the audible format into recognizable speech signals that are then presented to a recipient.

### TECHNICAL STATEMENT

This invention relates to text-to-speech technology, and more specifically, to architecture that converts data and/or text to speech signals, and routes the speech signals to one or more devices and systems.

### BACKGROUND

The rapid evolution of electronics has in many ways changed the way people interact with tools. No longer are tools simply a hammer or a screwdriver. Rather tools with integrated electronics have become far more sophisticated to operate and general to interact with. For example, the principal tool nowadays can be a computer or a handheld portable wireless device. HMI (human-machine interface) is a technology that seeks to describe this human-machine intercept.

Conventional HMI/automation control systems are limited in their capability to make users aware of situations that require their attention or of information that may be of interest to them relative to their current tasks. Where such mechanisms do exist, they tend to be either overly intrusive (e.g., interrupting the user's current activity by “popping up” an alarm display on top of whatever they were currently looking at) or not informative enough (e.g., indicating that something requires the user's attention but not providing sufficient information about what requires their attention). In many cases, the user must navigate to another display (e.g., a “detail screen”, “alarm summary” or “help screen”) to determine the nature of the information or even to determine whether such information exists.

Moreover, oftentimes people want a synopsis of what is happening in the facility or what tasks are planned for the immediate future. However, those people could be driving to work or doing a task that does not allow them to read or look at visual information. One workaround in light of such limitations is to phone associates at work and ask to be given an update. However, this can still be problematic in that the person may not be on station to provide the desired information.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

Oftentimes people want a synopsis of what is happening in a facility or what tasks are planned for the immediate future. However, in such a mobile society, people are driving to work or doing a task that does not allow them to read or look at visual information. The subject invention allows this type of mobile user to receive audible speech information as to the status of a system at the facility. When employed in an industrial automation environment, the input text can be generated by the automation system from alarm logs, notification messages, status messages, operational parameters, and the like, for example. Other information that can be converted includes current alarm conditions, production numbers, work orders to be executed, planned maintenance information, and messages from other people.

In another example, it is typical that, from an operator station that can provide a variety of windows as to systems that are being controlled, information is continually or periodically displayed in sidebar areas of the main window. This information can also be converted and output as speech so that the operator need not visually scan the associated data, but can focus visual attention in other areas while listening to the system information being output via speech. In other environments, there is no limit to the types of information that can be converted and output as speech. For example, stock quotes can be retrieved and output as speech to a recipient via radio signals as they are driving a vehicle, or output as speech via a telephone.

Additionally, the type and source of information can be determined by the person receiving the information, the location of the facility or system, and task being monitored, for example. Another user of the system can also designate information of interest to a specific person/role/next shift.

In another aspect of the subject invention the speech output can be scheduled for delivery at predetermined times for perception by the user.

In yet another aspect, the speech output can be routed to selected output devices and/or systems at the predetermined times, or at any time.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates report generation and output in accordance with an innovative aspect.

FIG. 2 illustrates a methodology of generating text-to-speech output of a report.

FIG. 3 illustrates a system that receives and processes data from various types of data sources in accordance with another aspect.

FIG. 4 illustrates a system that receives and processes data from various types of data sources to output speech in accordance with another aspect.

FIG. 5 illustrates a system that employs a template library that can be accessed for ordering data/text for speech output in accordance with another aspect.

FIG. 6 illustrates a methodology of providing templates as a means of ordering speech output in accordance with the disclosed innovation.

FIG. 7 illustrates a system that employs a routing component to route the speech signals to an output device in accordance with another aspect.

FIG. 8 illustrates a methodology of routing speech output in accordance with an innovative aspect.

FIG. 9 illustrates a system that employs a scheduling component for scheduling various aspects of text-to-speech processing in accordance with another aspect.

FIG. 10 illustrates a methodology of scheduling speech output in accordance with an innovative aspect.

FIG. 11 illustrates a screenshot of a webpage that provides a user interface at an operator station to monitor and control an industrial process.

FIG. 12 illustrates a system that distribute text-to-speech to different types of devices.

FIG. 13 illustrates a block diagram of a computer operable to execute the disclosed architecture.

FIG. 14 illustrates a schematic block diagram of an exemplary computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

While certain ways of displaying information to users are shown and described with respect to certain figures as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

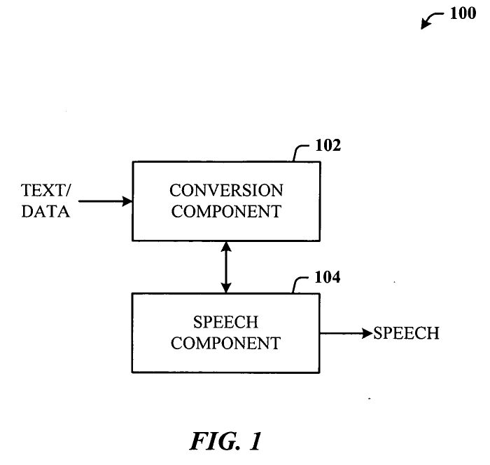

Referring initially to the drawings, FIG. 1 illustrates a system 100 that facilitates report generation and output in accordance with an innovative aspect. The system 100 can include a conversion component 102 that receives text of the report and converts the text into an audible format, and a speech component 104 that receives the audible format and presents (or outputs) the text as recognizable speech. The speech component 104 can include a text-to-speech engine (not shown) that processes the audible format into recognizable speech signals that are then presented to a recipient. The recipient can then determine when to listen to the message.

Oftentimes people want a synopsis of what is happening in a facility or what tasks are planned for the immediate future. However, in such a mobile society, people are driving to work or doing a task that does not allow them to read or look at visual information. The subject invention allows this type of mobile user to receive audible speech information as to the status of a system at the facility. When employed in an industrial automation environment, the input text can be generated by the automation system from alarm logs, notification messages, status messages, operational parameters, and the like, for example. Other information that can be converted includes current alarm conditions, production numbers, work orders to be executed, planned maintenance information, and messages from other people.

In another example, it is typical that, from an operator station that can provide a variety of windows as to systems that are being controlled, information is continually or periodically displayed in sidebar areas of the main window. This information can also be converted and output as speech so that the operator need not scan the associated data, but can focus visual attention in other areas while listening to the system information being output via speech. In other environments, there is no limit to the types of information that can be converted and output as speech. For example, stock quotes can be retrieved and output as speech to a recipient via radio signals as they are driving a vehicle, or output as speech via a telephone.

Additionally, the type and source of information can be determined by the person receiving the information, the location of the facility or system, and task being monitored, for example. Another user of the system can also designate information of interest to a specific person/role/next shift.

This system 100 facilitates the creation of an audible report that can be listened to via digital radio, voice mail, podcast (a method of publishing audio broadcasts via the Internet, allowing users to subscribe to a feed of new files such as usually MP3's), an MP3 device, or streaming audio, for example. Additionally, the content can be generated from pre-configured reports, which will be described in greater detail infra. The system 100 can also create the file that contains the requested information on demand or on schedule.

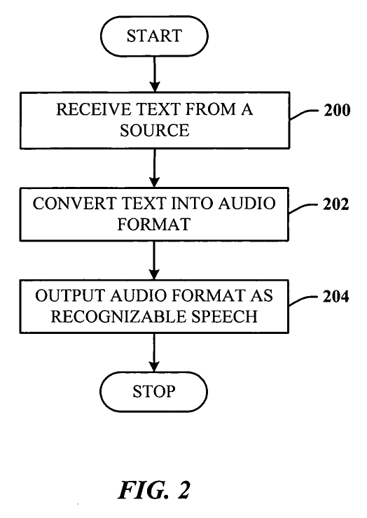

FIG. 2 illustrates a methodology of generating text-to-speech output of a report. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. At 200, data or text is received from a source. At 202, the data or text is converted into an audio format. At 204, the audio format is output as recognizable speech.

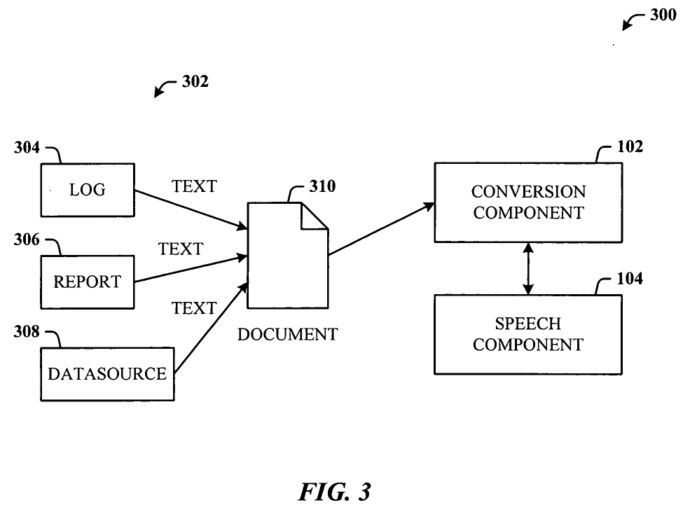

Referring now to FIG. 3, there is illustrated a system 300 that receives and processes data from various types of data sources 302 in accordance with another aspect. The system 300 can include the conversion component 102 and speech component 104 of FIG. 1 that receive and process textual input to ultimately output corresponding speech. In this implementation, the sources 302 include a log file 304, a report 306, and a datasource 308. The datasource 308 can be any kind of device (e.g., PLC-programmable logic controller), software, or system that outputs data (or text) which can be converted into text, and then to speech. For example, the datasource 308 can include a user interface (UI) that displays both graphical and textual information to a station operator in an industrial environment. The graphical information, textual information, and/or alphanumeric data displayed via the UI can be converted into speech for perception by a recipient.

Here, all or portions of data and/or text from one or more of the sources 302 are entered into an intermediary document 310. The document 310 is then processed by the conversion component 102 into an audible file format for processing by the speech component 104, the output of which is speech. The document 310 can be of a predesigned format such as a template wherein data is directed to specific areas therein. For example, the document 310 may begin by requesting that log data be placed first or at the top, followed by report data, and then ending with datasource data. The document 310 can be any document format (e.g., XML) insofar as it is suitable for conversion into an audio file format.

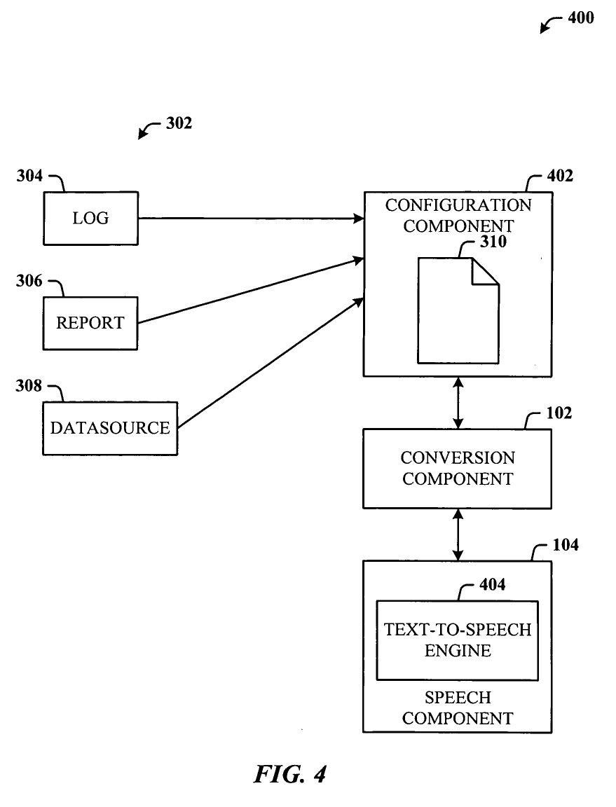

FIG. 4 illustrates a system 400 that receives and processes data from various types of data sources 302 to output speech in accordance with another aspect. The system 400 includes a configuration component 402 that facilitates configuration of data and/or text into the document 310 for conversion into speech. The configuration component 402 facilitates placement of the data/text into the document in any manner desired by the user. Once configured the data is passed to the conversion component 102 where it is converted into an audio format. The speech component 104 includes a text-to-speech engine 404 that receives the audio format and converts it into speech signals for output to the user. Note that the configuration component 402 can include a prioritization algorithm that prioritizes what data/text should be inserted into the document 310, where there is more data/text then room on the document. For example, it can be appreciated that the document and/or document file size can be a factor that is considered in the conversion and output process such that a document or file that is too large will be rejected or slow down the conversion and delivery of the text as speech to the end user. Thus, a rejected document or file can be re-processed to reduce the size such that more efficient conversion and delivery can be provided.

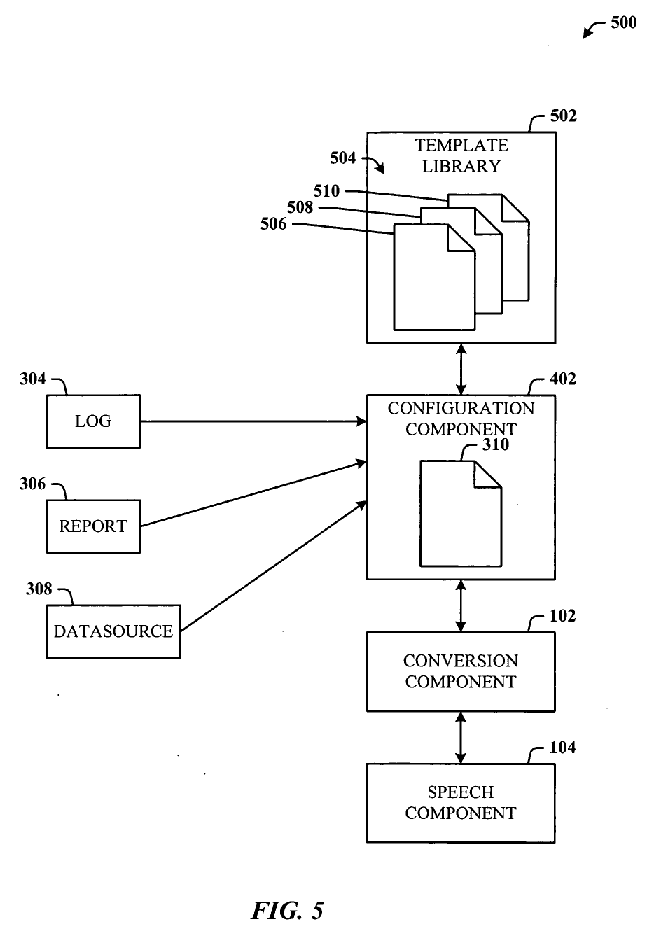

FIG. 5 illustrates a system 500 that employs a template library 502 that can be accessed for ordering data/text for speech output in accordance with another aspect. The library 502 can include any number of templates 504 that are selectable for various types of input data/text and/or output format or order of the desired speech. For example, if the user chooses to access log information 304, a first template 506 designed only for processing log information 304 can be retrieved from the template library 502 into the configuration component 402 for receiving log information in the desired format of the first template 506.

Similarly, if the user chooses to access report information 306 of a specific industrial process, a second template 508 of the template library 502 can be retrieved by the configuration component 402 for receiving the report information in the format of the second template 508. Further, if the user chooses a mix of different sources of information, a third template 510 of the template library 502 can be retrieved by the configuration component 402 for receiving both log information 304 and report information 306 in the order required according to the third template 510. In all cases, once the template has been filled with information, it is passed as the document 310 to the conversion component 102 for conversion into an audible format (e.g., WAV file, MP3 file, . . . ) that can be processed into speech by the speech component 104. It is to be appreciated that there can be many types of templates for structuring the text for speech output. A default set of templates can be provided along with software that allows a user to custom design templates for specific applications.

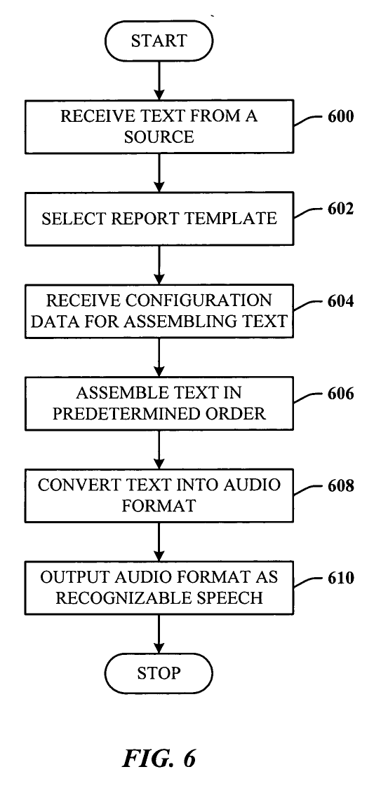

Referring now to FIG. 6, there is illustrated a methodology of providing templates as a means of ordering speech output in accordance with the disclosed innovation. At 600, text and/or data are received from a source. At 602, a template is selected for structuring the data and/or text. At 604, the configuration component processes the template to access configuration data associated therewith in order to receive and direct the data and/or text according to the template structure. At 606, the configuration component assembles the text and/or data into the document. At 608, the document is passed to the conversion component of conversion into an audible or audio format. At 610, the speech component receives and processes the audible or audio format into speech and presents the speech to the user.

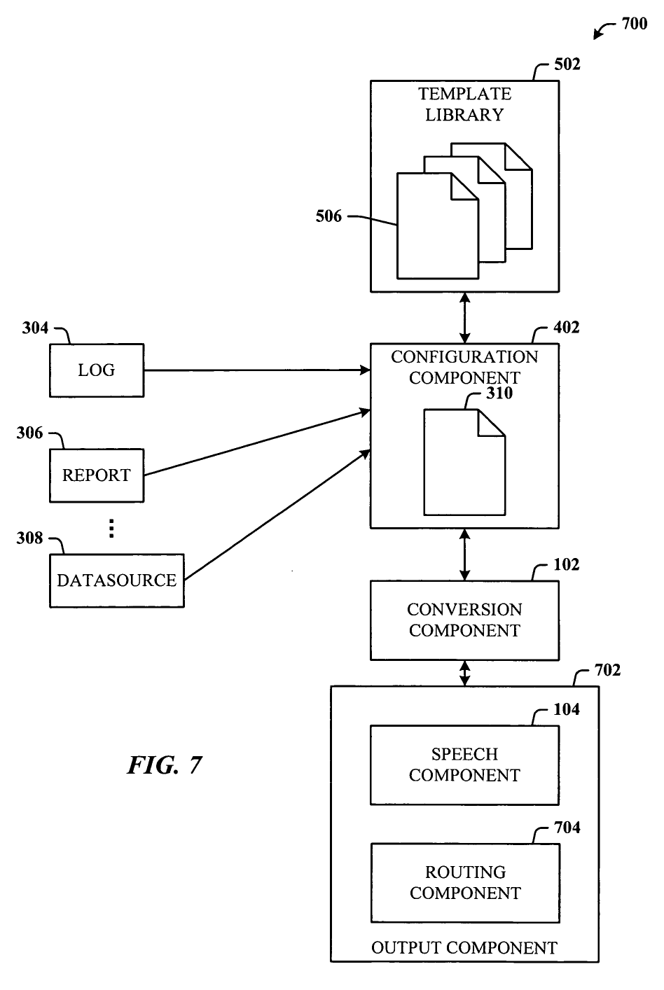

FIG. 7 illustrates a system 700 that employs a routing component to route the speech signals to an output device in accordance with another aspect. Here, the system 700 employs an output component 702 which includes the speech component 104 and a routing component 704. The routing component 704 receives the speech output and routes the output to the desire output device. The output device or system can be included as part of the template data or setup. For example, if the user chooses to receive an update on log information 304, the appropriate template 506 is received from the template library 502 into the configuration component 402 and the log information 304 is received thereinto to form the document 310. The document 310 is passed to the conversion component 102 which converts the log information into the audio format. The audio format is passed to the output component 702 along with the routing information that is included in the template 506. The speech component 104 processes the audio format into speech, and the routing component receives the routing information and processes it to determine the ultimate destination to send the speech output.

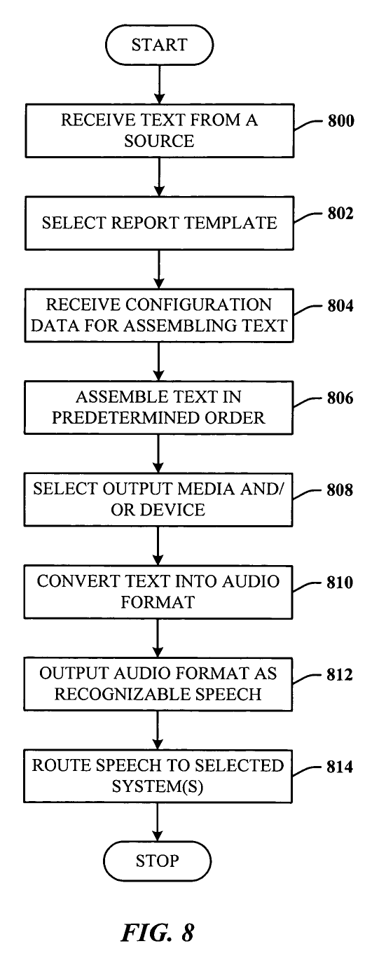

FIG. 8 illustrates a methodology of routing speech output in accordance with an innovative aspect. At 800, text is received form a source. At 802, a template is selected from the template library. At 804, configuration data associated with the template for assembling and ordering the text is extracted by the configuration component. At 806, the text is assembled and ordered into a document according to the configuration information. At 808, the output device and/or system(s) are selected. It is to be appreciated that the user can select not only a single device for output, but multiple same or different devices. At 810, once filled, the template is passed as a document to the conversion component for conversion into an audio file. The audio file is then processed by the speech component into speech signals, as indicated at 812. At 814, the speech signals are then routed to the selected system(s).

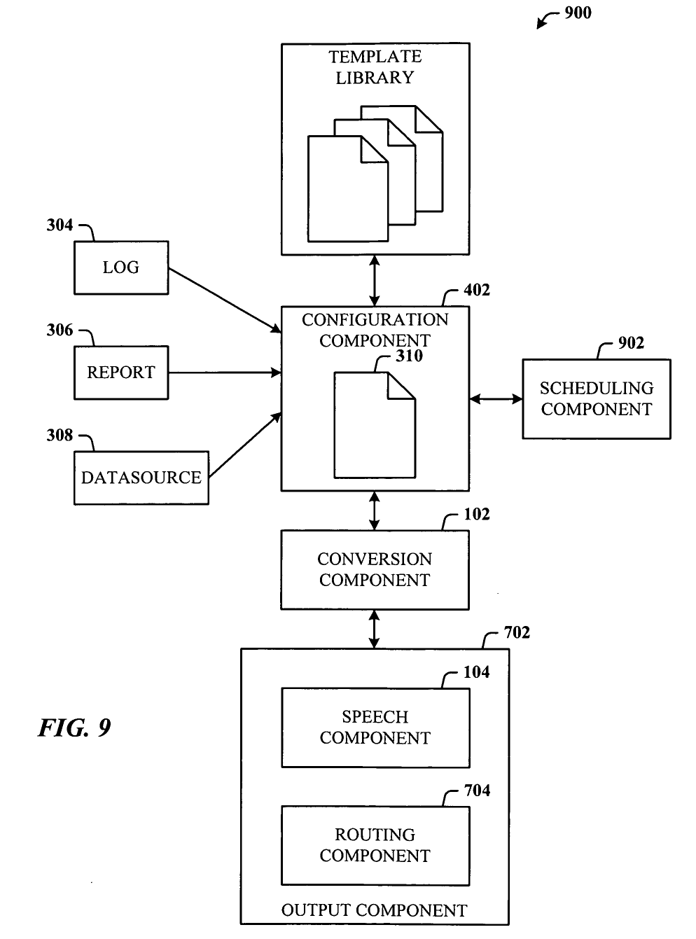

FIG. 9 illustrates a system 900 that employs a scheduling component 902 for scheduling various aspects of text-to-speech processing in accordance with another aspect. Here, the system 900 employs the scheduling component 902 to initiate speech output at predetermined times. For example, a user can schedule to hear log updates at 8:30 AM each morning as he drives to work, the corresponding log speech being output via a car radio or digital satellite radio system. In operation, the log information 304 is received into the configuration component 402, and into a template selected by the user from the template library 502. Once all the log information is present in the template, scheduling information can be attached or associated as metadata of the document 310, which is then passed to the conversion component 102 for converting into the audio file. The output component 702 receives the converted audio file and processes it into speech signals via the speech component 104. The routing component 704 then processes the speech signals for routing to designated devices, but according to the scheduling information originally associated with document 310. When the time arrives, the routing component 704 executes delivery of the speech signals to the selected output devices and/or systems.

Similarly, the user can schedule to hear sidebar data reports from the datasource 308 beginning at 9:30 AM and running at 30-second intervals for two minutes, each morning as he drives to work, the corresponding report speech being output via an MP3 player system. In operation, the data reports information 308 is received into the configuration component 402, and into a template selected by the user from the template library 502. Once all the data reports information is present in the template, scheduling information can be attached or associated as metadata of the document 310, which is then passed to the conversion component 102 for converting into an MP3 audio file. This format can be selected and passed as document metadata from the configuration component 402 to the conversion component 102. The output component 702 receives the converted audio file and processes it into speech signals via the speech component 104. The routing component 704 then processes the speech signals for routing to a designated MP3 device, but according to the scheduling information originally associated with document 310. When the time arrives, the routing component 704 executes delivery of the speech signals to the selected output MP3 device, and according to the interval and duration information.

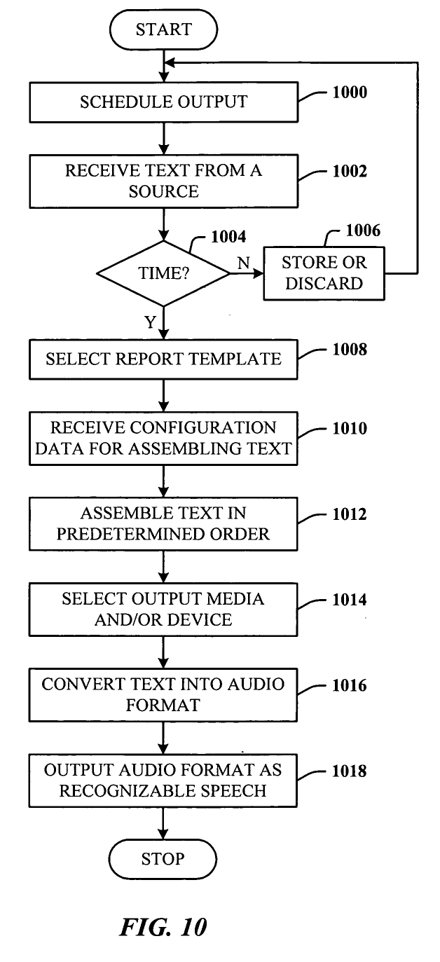

FIG. 10 illustrates a methodology of scheduling speech output in accordance with an innovative aspect. At 1000, the user schedules the desired output. At 1002, the desired text is received for a source. At 1004, the system determines if the appointed time has arrived. If not, flow is to 1006 where the data can be either stored or discarded. Flow is then back to 1000 to process the next schedule. The act of storing can be a caching process that caches the data in anticipation of the data being requested again in the very near future. After a predetermined period of time, the data can be aged out of memory. If, at 1004, the time has arrived, flow is to 1008 where a report template is selected. At 1010, configuration data from the template is extracted for assembling the desired text. At 1012, the text is input into the template or document in the order required of the template. At 1014, an output device is selected to receive and present the speech output. At 1016, the text document is passed to the conversion component for conversion into an audio file format. At 1018, the audio file is converted into speech and output via the selected device(s).

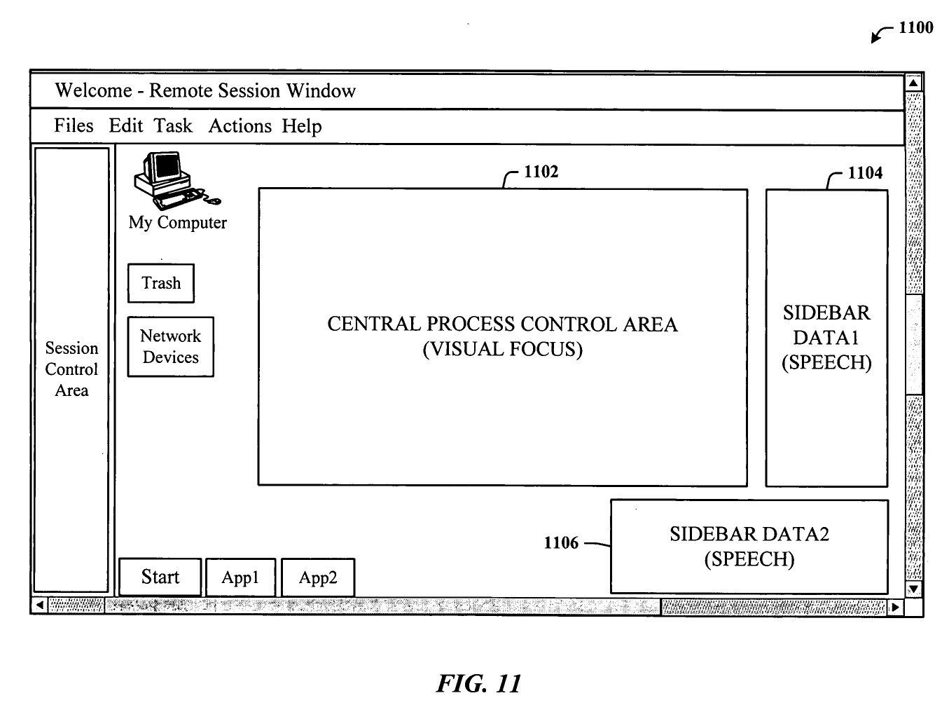

FIG. 11 illustrates a screenshot of a webpage 1100 that provides a user interface at an operator station to monitor and control an industrial process. The webpage 1100 can include a central viewing area 1102 that presents more important aspects of a process or operation under control. The page 1100 can also include sidebar areas: a first sidebar area 1104 that can display data related to a peripheral aspect of the process, and a second sidebar area 1106 that presents other data related to a part of the operation being controlled, for example. In one implementation, the central viewing area 1102 is perceived visually, while the sidebar areas (1104 and 1106) can be perceived aurally. In any case, data and/or text of any of the areas (1102, 1104, and 1006) can be selected for import into a template and ultimate conversion into speech signals for output to one or more selected output devices and/or systems.

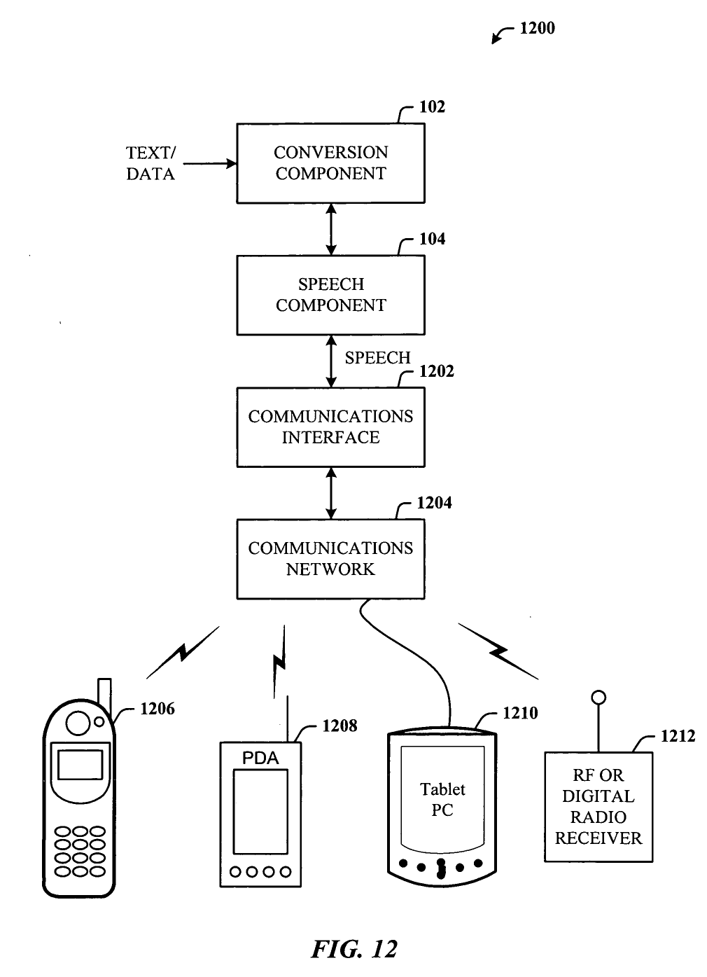

FIG. 12 illustrates a system 1200 that distribute text-to-speech to different types of devices. The text and/or data are received into the conversion component 102 for conversion into an audio file. The audio file is passed to the speech component 104 for conversion into speech signals and then to a communications interface 1202 for communications processing over one or more communications networks 1204. The communications network 1204 can be any of a number of different types of networks, for example, an IP packet-based network such as the Internet, a mobile communications network (e.g., 2G, 3G, . . . ) and, RF and digital radio networks, for example. It is to be appreciated that any communications network over which speech signals can be communicated is to be considered as to be within contemplation of the communications network 1204. For example, the communications network 1204 can include technology that facilitates delivery of the speech signals wirelessly to a cellular telephone 1206, a PDA 1208, and over a wired connection to a tablet PC, and wireless FM or AM to an FM/AM radio 1212 and/or digital radio signals to the digital radio 1212.

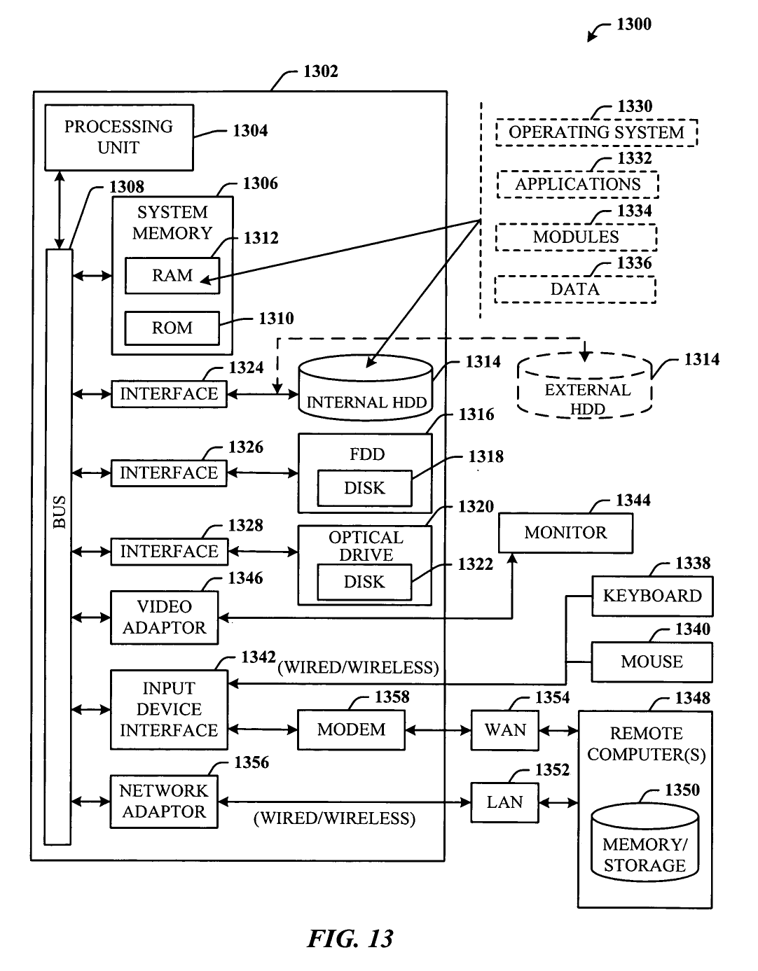

Referring now to FIG. 13, there is illustrated a block diagram of a computer operable to execute the disclosed architecture. In order to provide additional context for various aspects thereof, FIG. 13 and the following discussion are intended to provide a brief, general description of a suitable computing environment 1300 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 13, the exemplary environment 1300 for implementing various aspects includes a computer 1302, the computer 1302 including a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multi-processor architectures may also be employed as the processing unit 1304.

The system bus 1308 can be any of several types of bus structure that may further interconnect to a memory bus (with or without a memory controller), a peripheral bus, and a local bus using any of a variety of commercially available bus architectures. The system memory 1306 includes read-only memory (ROM) 1310 and random access memory (RAM) 1312. A basic input/output system (BIOS) is stored in a non-volatile memory 1310 such as ROM, EPROM, EEPROM, which BIOS contains the basic routines that help to transfer information between elements within the computer 1302, such as during start-up. The RAM 1312 can also include a high-speed RAM such as static RAM for caching data.

The computer 1302 further includes an internal hard disk drive (HDD) 1314 (e.g., EIDE, SATA), which internal hard disk drive 1314 may also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The hard disk drive 1314, magnetic disk drive 1316 and optical disk drive 1320 can be connected to the system bus 1308 by a hard disk drive interface 1324, a magnetic disk drive interface 1326 and an optical drive interface 1328, respectively. The interface 1324 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1302, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1312, including an operating system 1330, one or more application programs 1332, other program modules 1334 and program data 1336. All or portions of the operating system, applications, modules, and/or data can also be cached in the RAM 1312. It is to be appreciated that the innovation can be implemented with various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) may include a microphone, an IR remote control, a joystick, a game pad, a stylus pen, touch screen, or the like. These and other input devices are often connected to the processing unit 1304 through an input device interface 1342 that is coupled to the system bus 1308, but can be connected by other interfaces, such as a parallel port, an IEEE 1394 serial port, a game port, a USB port, an IR interface, etc.

A monitor 1344 or other type of display device is also connected to the system bus 1308 via an interface, such as a video adapter 1346. In addition to the monitor 1344, a computer typically includes other peripheral output devices (not shown), such as speakers, printers, etc.

The computer 1302 may operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically includes many or all of the elements described relative to the computer 1302, although, for purposes of brevity, only a memory/storage device 1350 is illustrated. The logical connections depicted include wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which may connect to a global communications network, e.g., the Internet.

When used in a LAN networking environment, the computer 1302 is connected to the local network 1352 through a wired and/or wireless communication network interface or adapter 1356. The adaptor 1356 may facilitate wired or wireless communication to the LAN 1352, which may also include a wireless access point disposed thereon for communicating with the wireless adaptor 1356.

When used in a WAN networking environment, the computer 1302 can include a modem 1358, or is connected to a communications server on the WAN 1354, or has other means for establishing communications over the WAN 1354, such as by way of the Internet. The modem 1358, which can be internal or external and a wired or wireless device, is connected to the system bus 1308 via the serial port interface 1342. In a networked environment, program modules depicted relative to the computer 1302, or portions thereof, can be stored in the remote memory/storage device 1350. It will be appreciated that the network connections shown are exemplary and other means of establishing a communications link between the computers can be used.

The computer 1302 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

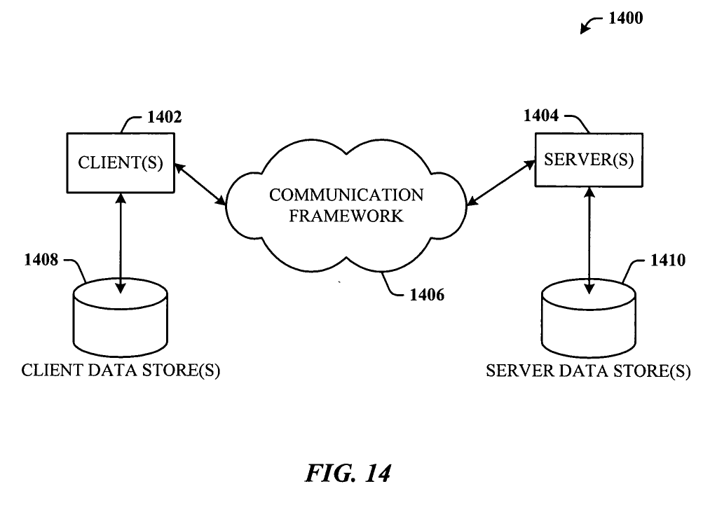

Referring now to FIG. 14, there is illustrated a schematic block diagram of an exemplary computing environment 1400 in accordance with another aspect. The system 1400 includes one or more client(s) 1402. The client(s) 1402 can be hardware and/or software (e.g., threads, processes, computing devices). The client(s) 1402 can house cookie(s) and/or associated contextual information by employing the subject innovation, for example.

The system 1400 also includes one or more server(s) 1404. The server(s) 1404 can also be hardware and/or software (e.g., threads, processes, computing devices). The servers 1404 can house threads to perform transformations by employing the invention, for example. One possible communication between a client 1402 and a server 1404 can be in the form of a data packet adapted to be transmitted between two or more computer processes. The data packet may include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates generation and output speech signals, comprising:
a conversion component that receives and converts text and/or data of an industrial monitor and control system into an audio file format;
a speech component that receives and converts the audio file format into speech signals; and
an output component that routes the speech signals to a predesignated user for presentation as recognizable speech signals.

2. The system of claim 1, wherein the audible format is aurally perceived by the user via at least one of a digital radio, an FM radio, voice mail, podcast, an MP3 device and streaming audio.

3. The system of claim 1, further comprising a scheduling component that facilitates generation of scheduling data, the execution of which delivers the text and/or data to the user at a predetermined time.

4. The system of claim 3, wherein the scheduling data includes a start time for initiating delivery of the speech signals, a duration time that indicates a span of time over which the speech signals are delivered, and an interval time for the number of times the speech signals are delivered during the time duration.

5. The system of claim 1, further comprising a configuration component that configures the text and/or data into a document that is converted into the audio file format by the conversion component.

6. The system of claim 5, wherein the audio file format is an MP3 format.

7. The system of claim 1, further comprising a template library that includes a plurality of templates each of which defines an order in which the text and/or data are delivered as speech signals.

8. The system of claim 7, wherein one of the templates includes scheduling data.

9. The system of claim 7, wherein one of the templates includes routing data that routes the speech signals to an output device.

10. The system of claim 8, wherein the output device is selectable by the user.

11. The system of claim 1, wherein the speech signals are requested on-demand for output to a device that is selectable by the user.

12. The system of claim 1, wherein the speech signals are requested on-demand for output to a number of different devices that are selectable by the user.

13. The system of claim 1, wherein the speech signals are requested for output to a number of different devices each at different times and which are selectable by the user.

14. The system of claim 1, wherein the text and/or data are received from a programmable logic controller.

15. A system that facilitates generation and output of speech signals, comprising:
a conversion component that receives and converts text and/or data into an audio file format;
a configuration component that configures the text and/or data for processing;
a speech component that receives the audio file format and presents the text and/or data to a user as recognizable speech signals; and
a scheduling component that generates scheduling data that is processed to initiate delivery of the speech signals.

16. The system of claim 15, further comprising a template library of one or more templates that define an ordering of the data and/or text in a document.

17. The system of claim 16, wherein the one or more templates are processed by the configuration component to obtain metadata that defines a type of data and/or text that is received, scheduling data that schedules when the speech signals are delivered to the user, and routing data.

18. The system of claim 16, wherein one of the templates facilitates input of text from multiple different sources.

19. The system of claim 15, wherein the text and/or data is generated from an industrial environment and is converted into the speech signals for output via a digital radio and a cellular telephone.

20. The system of claim 15, wherein the speech signals are stored for output at a later time.

21. The system of claim 15, further comprising a routing component that routes the speech signals to a user-selected output device.

22. The system of claim 15, wherein the data and/or text that are presented on a user interface is converted by the conversion component for perception as the speech signals by a user.

23. A method of generating speech signals, comprising:
receiving text and/or data;
configuring the text and/or data for conversion processing;
converting the text and/or data into an audio file format;
scheduling the audio file format for output processing;
processing the audio file format into the speech signals; and
playing the speech signals to a user.

24. The method of claim 23, further comprising an act of prioritizing input of the text and/or data into a template based in part upon file size and duration of play.

25. The method of claim 23, further comprising an act of assembling the text and/or data into a predetermined order before the act of converting.

26. The method of claim 23, further comprising an act of routing the speech signals to an FM radio to facilitate the act of playing.

27. The method of claim 23, further comprising an act of routing the speech signal over a cellular network for perception by the user via a cellular telephone.

28. The method of claim 23, further comprising an act of routing the speech signals to another user at a later time.

29. The method of claim 23, further comprising an act of automatically determining a user to whom the speech signals are routed based on location of the user.

30. The method of claim 23, further comprising an act of automatically determining a user to whom the speech signals are routed based on a task that is being monitored.

31. The method of claim 23, wherein the text and/or data includes at least one of current alarm conditions, production numbers, work order to be executed, planned maintenance information, and messages for another person.

32. A system that generates speech signals, comprising:
means for receiving text and/or data;
means for configuring the text and/or data for conversion processing;
means for converting the text and/or data into an audio file format;
means for scheduling the audio file format for output processing;
means for processing the audio file format into the speech signals;
means for automatically routing the speech signals to a user who is associated with a specific location; and
means for playing the speech signals to the user.
